(19) United States
(12) Patent Application Publication
(10) Pub. No.: US 2008/0181772 A1
(43) Pub. Date: Jul. 31, 2008

(54) CONDUCTIVE DEVICE FOR COOLING FAN WITH LUMINOUS FIGURES

(76) Inventors: Wen-Hao Liu, Kaohsiung (TW); Bing-Tsang Ho, Kaohsiung (TW)

Correspondence Address: G. LINK CO., LTD., 3550 BELL ROAD, MINOOKA, IL, 60447, US

(21) Appl. No.: 11/668,274

(22) Filed: Jan. 29, 2007

(51) Int. Cl. F04D 29/00; F04B 53/08; F21V 33/00

(52) U.S. Cl. 416/5; 417/313; 362/96

(57) ABSTRACT

A conductive device for a cooling fan with luminous figures provides a first circuit board, which surrounds and fits with the axial barrel in the fan frame, and the first and second conductors of the first circuit board connect with the first and second bearings respectively. The central shaft of the fan wheel fits with the first and second bearings and is surrounded with an elastic member on top of the first bearing. An insulation portion of the shaft is disposed at a position corresponding the first bearing and the elastic member. A second circuit board, which is attached to one of the blades on the fan wheel, provides luminous components and contacts with the elastic member and the shaft respectively. Once the fan is powered on and electricity is reached to the second circuit board via the first and second conductors, the first and second bearings and the elastic member, the luminous component is lighted up to show bright figures along with running fan wheel.

### BACKGROUND OF THE INVENTION

1. Field of the Invention

The present invention is related to a cooling fan with luminous figures and particularly to a conductive device, which provides a circuit board with luminous components attached to a blade of a cooling fan.

2. Brief Description of the Related Art

The conventional cooling fan with luminous figures provides a soft circuit board with a plurality of illumining components mounted to the blades of the fan. Then, the luminous members are controlled with timing control circuit to brighten sequentially. Once the blades are rotated, preset figures or characters are formed due to visual temporary stay of human eyes.

The conductive device in a cooling fan with luminous figures, which is disclosed in Taiwan utility Model No. M286561, provides a soft circuit board with luminous components being associated with a blade of the fan wheel and the fan is provided with magnet and a central shaft. The shaft is joined to a coil set and it is characterized in that the central shaft has an outer tube and an inner shaft part disposed in the outer tube and extending outward the outer tube, an insulation member is arranged between the inner shaft part and the outer tube, the inner shaft part and the outer tube are connected to the soft circuit board electrically, the coil set contains two bearings, which fit with the outer tube and the inner shaft part respectively, and the positive and negative conductors are connected to the bearings respectively such that electricity is sent to the soft circuit board via the outer tube and the inner shaft part to allow the luminous component showing bright figures while the fan wheel rotates.

While the preceding prior art is implemented, the surface of inner shaft part being formed the insulation member and the outer tube surrounding the insulation member make the fabrication job tedious to increase the production cost. Further, it is easy for the outer tube to loosen apart from the inner shaft part after using a period of time and it results in serious swaying during the fan running.

### SUMMARY OF THE INVENTION

Accordingly, in order to solve the preceding problems, an object of the present invention is to provide a cooling fan device with luminous figures in which an elastic member and a central shaft transmits the positive and negative power source to the second circuit board with luminous components via the elastic member and the central shaft without interfering rotation of the fan wheel.

Another object of the invention is to provide a conductive device for a cooling fan device with luminous figures in which the central shaft is integrated with the conductive device to decrease fabrication process and cost and to respond rotational speed of the fan wheel exactly.

In order to achieve the preceding object, a cooling fan with luminous figures includes a base, a stator, a fan wheel and a central shaft. The base provides an axial barrel, an elastic member, a first bearing and a second bearing. The first bearing and the second bearing are disposed in the barrel in a way of spacing apart from each other and the elastic member being disposed in the barrel on top of the first bearing. The stator is disposed to surround and fit with the barrel and provides a first circuit board with a first conductor and a second conductor being connected to the first bearing and the second bearing respectively. The fan wheel provides a hub with a plurality of blades being joined to a circumferential wall of the hub. At least one of the blades is attached with a second circuit board, which is provided with at least an luminous component. A first side of the second circuit board contacts the elastic member and a second side of the second circuit board contacts the central shaft. The central shaft is joined to a top of the hub to pass through the elastic member and fit with the first and the second bearings respectively and provides an insulation portion at a position corresponding to the elastic member and the first bearing.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of a cooling fan with luminous figures illustrating a conductive device according to the present invention;

FIG. 2 is an exploded sectional view of FIG. 1;

FIG. 3 is an assembled sectional view of FIG. 2;

FIG. 4 is a perspective view of the stator in the cooling fan according to the present invention; and

FIG. 5 is a perspective view of another embodiment of the stator in the cooling fan according to the present invention.

### DETAILED DESCRIPTION OF THE INVENTION

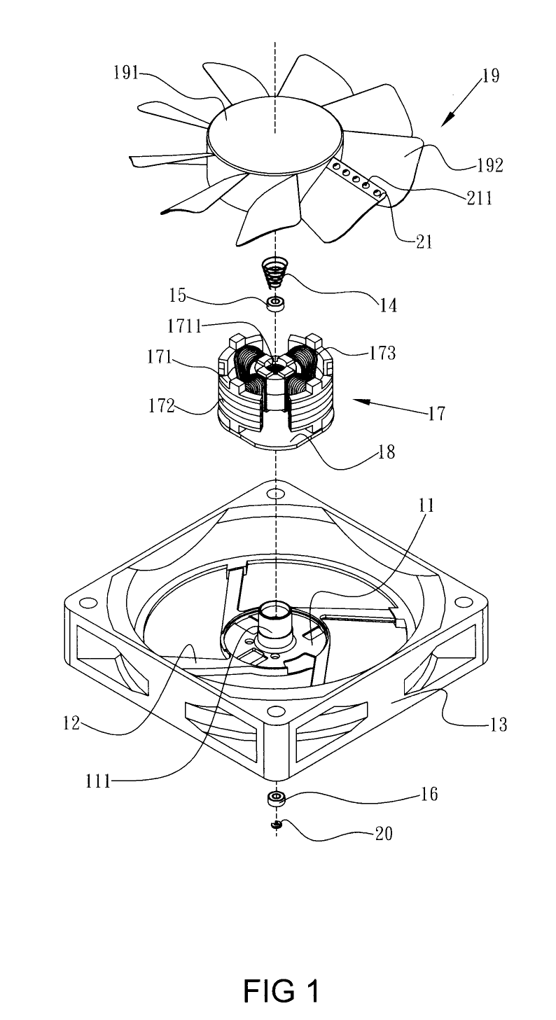

Referring to FIGS. 1 to 3, a preferred embodiment of a cooling fan with luminous figures according to the present invention provides a base 11, which is fixedly disposed at the center of a fan frame 13 by means of a plurality of holding members 12 as shown in FIG. 1. It is noted that the base 11 can be joined to a radiator or a heat generation component (not shown) instead. The base 11 has a barrel 111 with an annular projection 112 at the inner wall of the barrel 111. A first bearing 15 is placed on top of the annular projection 112 via the upper opening 1111 of the barrel 111 and a second bearing 16 is placed at the bottom of the annular projection 112 via the lower opening 16 of the barrel 16. An elastic member 14, which is a spring shown in FIGS. 1 to 3, is arranged on top of the first bearing 15.

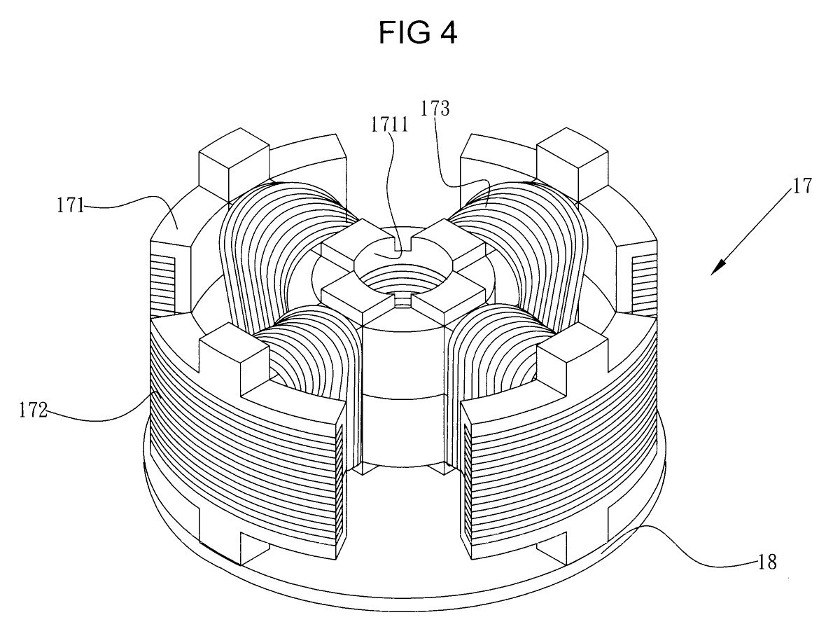

Referring to FIG. 4 in company with FIGS. 1 to 3, a stator set 17 provides an insulation frame 171 with a central hollow cylindrical part 1711 fitting with the outer surface of the barrel 111. A silicon-steel sheet set 172 is mounted to the insulation frame 171 and a coil 173 is employed to wind up the silicon-steel set 172. A first circuit board 18 is connected to a side of the insulation frame 171 and both ends of the coil 173 are electrically connected to the first circuit board 18. Further, the first circuit board 18 has a first conductor 181 and a second conductor 182 to connect with the first bearing 15 and the second bearing 16 respectively.

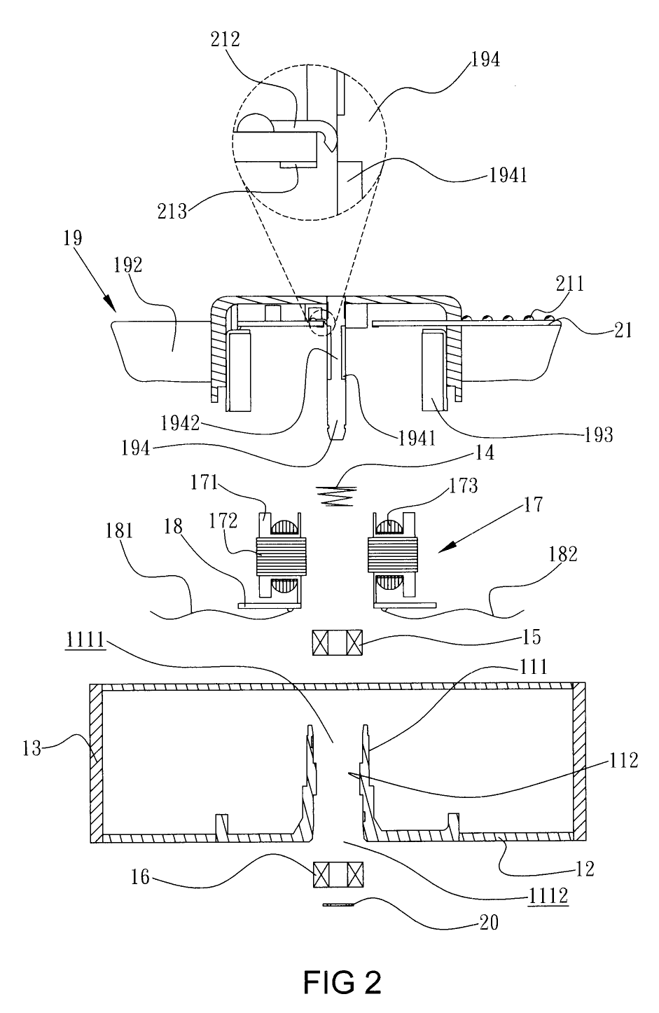

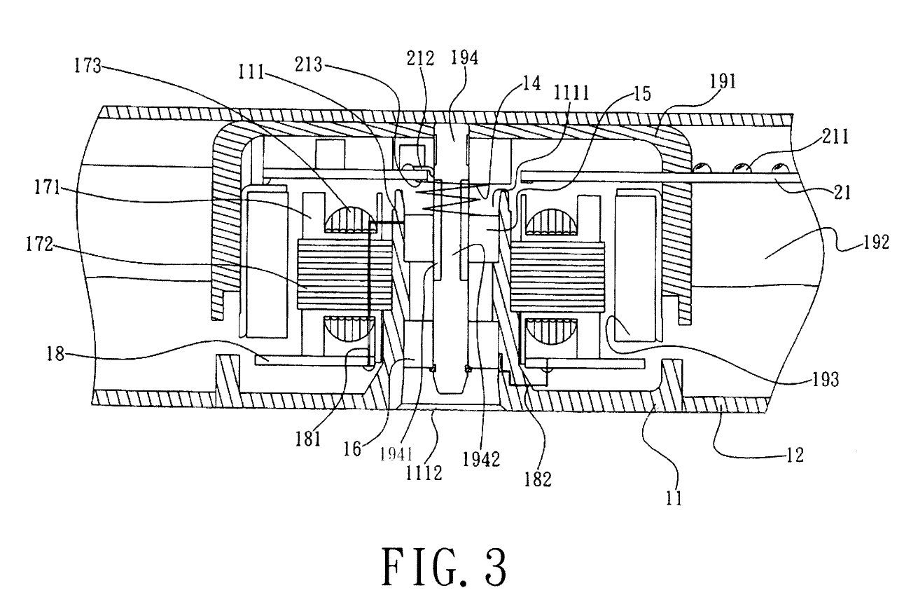

A fan wheel 19 includes a hub 191 and a plurality of blades 192 and the blades are attached to the circumferential wall of the hub 191. A magnet 193 is attached to the inner surface of the circumferential wall of the hub 191 and a central shaft 194 is joined to the center of the top side of the hub 191. The central shaft 194 passes through the elastic member 14 and fits with the first and second bearings 15, 16. A retaining ring 20 is disposed next to the second bearing 16 to engage with the central shaft 194 to retain the second bearing 16 in place firmly. The central shaft provides an insulation portion 1941 at a position corresponding to the elastic member 14 and the first bearing 15. A second circuit board 21 is joined to at least one of the blades 192 and at least one luminous component 211 is provided on the second circuit board 21. It is preferable that the second circuit board 21 is either a hard or soft circuit board and the luminous component 211 is either a light emitting diode (LED) or organic light emitting diode (OLED). It can be seen in FIGS. 2 and 3 that a section of the second circuit board 21 extends into the hub 191 via penetrating the circumferential wall of the hub 191. The second circuit board 21 has a first electrical contact 212 at a side thereof to touch the central shaft 194 and a second electrical contact 213 at another side thereof opposite to the first electrical contact 212 to touch the elastic member 14.

It is noted that the preceding structure of the second circuit board 21 with electrical contacts 213, 212 shown in FIGS. 2 and 3 is an explanatory example and the second circuit board 21 can be associated with electrical contacts outside the hub 191 as well.

The insulation portion 1941 of the central shaft 194 can be implemented in a way of the position of the central shaft 194 corresponding to the elastic member 14 and the first bearing 15 being formed a small diameter portion 1942, then the central shaft 194 being placed in a mold tool for making the fan wheel 19 and the insulation portion 1944 being formed and solidified at the small diameter portion 1942 along with the fan wheel 19 after the process of injection molding.

The first conductor 181 is connected to one of the positive and negative electrodes of the first circuit board 18 and the second conductor 182 is connected to another one of the electrodes. It is noted that the first conductor 181 is connected to the positive electrode and the second conductor 182 is connected to the negative electrode shown in FIG. 4. The first and second conductors 181, 182 are fixedly connected to the first circuit board 18 and the first and second bearings 15, 16 respectively with soldering.

Therefore, once the coil 173 is powered on to magnetize the magnet 193, the fan wheel 19 is induced to rotate with the positive electricity entering the second circuit 21 via the second conductor 182, the second bearing 16, the central shaft 194 and the first electrical contact 212 and the negative electricity entering the second circuit board 21 via the first conductor 181, the first bearing 15, the elastic member 14 and the second electrical contact 213. Hence, the luminous component 211 is capable of emitting light.

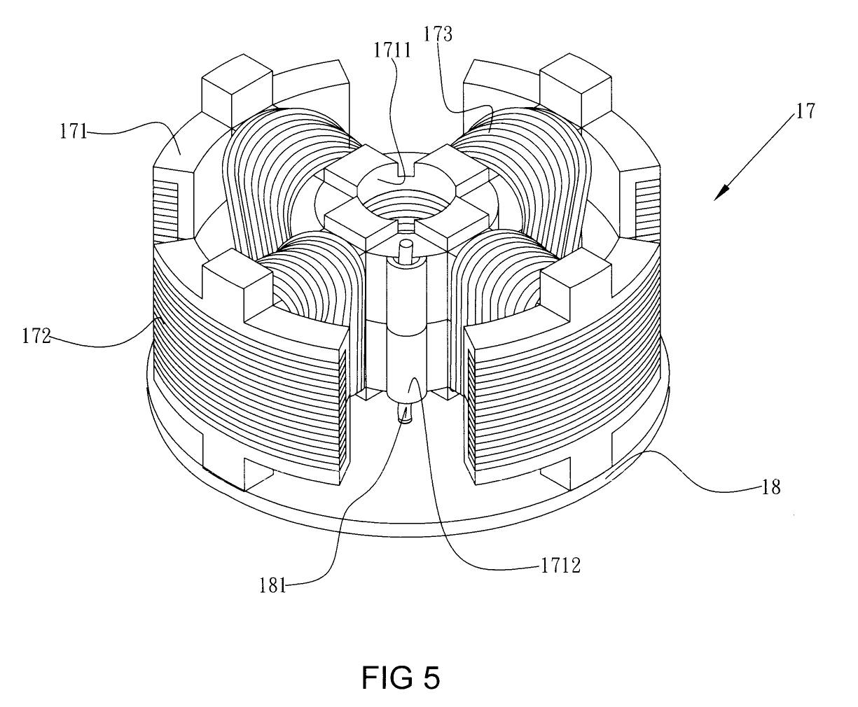

Referring to FIG. 5, another embodiment of the stator set 17 is illustrated. The difference of the second embodiment from the preceding first embodiment is in that the insulation frame 171 provides an insulation channel 1712 for being penetrated by one of the conductors 181, 182 to prevent from electrical interference between the conductor passing through the insulation channel 1712 and the coil 173. The conductor, which passes through the insulation channel 1712 shown in FIG. 5, is the first conductor 181.

Alternatively, one of the conductors 181, 182 is coated with a protect member and passes over the insulation frame 171 to avoid the first conductor 181 or the second conductor 182 creating electrical interference with the coil 173 in addition to being worked easily.

It is appreciated that the conductive device for a cooling fan with luminous figures according to the present invention has an integrated structure with the central shaft such that the conductive device not only does not interfere rotation of the fan wheel but also is capable of allowing the fan wheel to respond actual rotational speed for overcoming deficiencies of the outer tube separating from the inner shaft so as to lower fabricating process and cost.

While the invention has been described with referencing to preferred embodiments thereof, it is to be understood that modifications or variations may be easily made without departing from the spirit of this invention, which is defined by the appended claims.

What is claimed is:

1. A cooling fan with luminous figures comprising:
a base providing an axial barrel, an elastic member, a first bearing and a second bearing, the first bearing and the second bearing being disposed in the barrel in a way of spacing apart from each other and the elastic member being disposed in the barrel on top of the first bearing;
a stator being disposed to surround and fit with the barrel, providing a first circuit board with a first conductor and a second conductor being connected to the first bearing and the second bearing respectively;
a fan wheel providing a hub with a plurality of blades being joined to a circumferential wall of the hub, at least one of the blades being attached with a second circuit board, which is provided with at least an luminous component, a first side of the second circuit board contacting the elastic member; and
a central shaft being joined to a top of the hub to pass through the elastic member and fit with the first and the second bearings respectively, providing an insulation portion at a position corresponding to the elastic member and the first bearing and contacting a second side of the second circuit board.

2. The cooling fan with luminous figures as defined in claim 1, wherein the central shaft engages a retaining ring at an end thereof for retaining the second bearing in place.

3. The cooling fan with luminous figures as defined in claim 1, wherein the second circuit board is joined to the inner side or the outer side of the hub.

4. The cooling fan with luminous figures as defined in claim 1, wherein the first side of the second circuit board provides a first contact for contacting the elastic member.

5. The cooling fan with luminous figures as defined in claim 1, wherein the second side of the second circuit board provides a second contact for contacting central shaft.

6. The cooling fan with luminous figures as defined in claim 1, wherein the first conductor connects with one of a positive electrode and a negative electrode of the first circuit board.

7. A cooling fan with luminous figures comprising:
a base providing an axial barrel, an elastic member, a first bearing and a second bearing, the first bearing and the second bearing being disposed in the barrel in a way of spacing apart from each other and the elastic member being disposed in the barrel on top of the first bearing;
a stator being disposed to surround and fit with the barrel, providing an insulation frame and a first circuit board with a first conductor and a second conductor being connected to the first bearing and the second bearing respectively and insulation frame further providing an insulation channel available for one of the conductors passing through;
a fan wheel providing a hub with a plurality of blades being joined to a circumferential wall of the hub, at least one of the blades being attached with a second circuit board, which is provided with at least an luminous component, a first side of the second circuit board contacting the elastic member; and
a central shaft being joined to a top of the hub to pass through the elastic member and fit with the first and the second bearings respectively, providing an insulation portion at a position corresponding to the elastic member and the first bearing and contacting a second side of the second circuit board.

8. The cooling fan with luminous figures as defined in claim 7, wherein the central shaft engages a retaining ring at an end thereof for retaining the second bearing in place.

9. The cooling fan with luminous figures as defined in claim 7, wherein the second circuit board is joined to the inner side or the outer side of the hub.

10. The cooling fan with luminous figures as defined in claim 7, wherein the first side of the second circuit board provides a first contact for contacting the elastic member.

11. The cooling fan with luminous figures as defined in claim 7, wherein the second side of the second circuit board provides a second contact for contacting central shaft.

12. The cooling fan with luminous figures as defined in claim 7, wherein the first conductor connects with one of a positive electrode and a negative electrode of the first circuit board.

13. The cooling fan with luminous figures as defined in claim 1, wherein one of the conductors is coated with a protect member to pass over the insulation frame.

14. The cooling fan with luminous figures as defined in claim 7, wherein one of the conductors is coated with a protect member to pass over the insulation frame.
